(19) United States
(12) Patent Application Publication
(10) Pub. No.: US 2026/0016679 A1
(43) Pub. Date: Jan. 15, 2026

(54) OPTICAL ELEMENT, OPTICAL SYSTEM, AND OPTICAL DEVICE

(71) Applicant: CANON KABUSHIKI KAISHA, Tokyo (JP)

(72) Inventors: YUKINOBU OKURA, Tokyo (JP); TOMOYUKI AOYAGI, Kanagawa (JP); KANAKO SHIMBA, Tochigi (JP)

(21) Appl. No.: 19/261,181

(22) Filed: Jul. 7, 2025

(30) Foreign Application Priority Data
Jul. 10, 2024 (JP) 2024-111255
Jul. 10, 2024 (JP) 2024-111256

(51) Int. Cl. G02B 23/06; G02B 5/08; G02B 30/60

(52) U.S. Cl. CPC G02B 23/06; G02B 5/085; G02B 30/60

(57) ABSTRACT

An optical element includes a first face having a first reflecting region where a part of a light flux incident from a predetermined direction is reflected in a first direction, and a first non-optical region where the light flux is not incident, a second face having a second reflecting region where another part of the light flux incident from the predetermined direction is reflected in a second direction different from the first direction, and a third face connecting the first non-optical region and the second reflecting region. The first non-optical region and the third face form an acute angle outside the optical element. The second reflecting region and the third face form an acute angle inside the optical element.

### BACKGROUND

### Field of the Technology

The present disclosure relates to an optical element, an optical system, and optical device, that may be used in the field of astronomical observation.

### Description of the Related Art

In the field of astronomical observation, an observation method called face spectroscopy capable of simultaneously observing two-dimensional spatial information and spectral information is known. Optical systems that may be used for face spectroscopy include microlens array type optical systems, fiber bundle type optical systems, and image slicer type optical systems.

Although complicated, the image slicer optical systems are known as having little loss of spatial information and having high spatial resolution even in a narrow field of view. An image slicer-type face spectroscopic system may be formed by combining a slice mirror, a pupil mirror, and a slit mirror. The slice mirror is a mirror that splits a focal face image of a telescope into a plurality of elongated images. The pupil mirror is a mirror for one-dimensionally rearranging the images split by the slice mirror. The slit mirror is a mirror for emitting the optical images rearranged by the pupil mirror in a slit shape toward the spectroscope.

WO 2020/203975 A1 discloses a slice mirror formed by fastening a plurality of flat mirrors having elongated mirror faces to a fixing member using bolts.

JP 2016-21057 A discloses an optical element in which an intermediate layer having a thermal expansion coefficient between a thermal expansion coefficient of a substrate and a thermal expansion coefficient of a reflective layer is disposed between the substrate and the reflective layer as an optical element that can be used for image slicer-type face spectroscopy. By providing the intermediate layer, the optical element is suppressed from being damaged or deformed due to thermal influences.

For example, in the astronomy field, an optical element is required to have high shape accuracy in order to realize highly accurate observation. Meanwhile, for example, in a case where observation is performed in outer space, a mountainous area, a desert, or the like, the optical element can be installed at an environmental temperature different from the temperature at the time of manufacture (typically, normal temperature). In addition, in a case where the observation wavelength includes an infrared region, infrared light emitted as a black body radiation from the optical element itself may become observation noise, and thus the optical element is cooled to a temperature lower than normal temperature.

The slice mirror described in WO 2020/203975 A1 has an advantage in that it can be assembled in a relatively easy way. However, when it is placed in a temperature environment different from that at the time of manufacture as described above, it is difficult to maintain the position and posture and the shape of the fastened flat mirror with high accuracy.

Since the optical element described in JP 2016-21057 A includes the intermediate layer having a thermal expansion coefficient between the thermal expansion coefficient of the substrate and the thermal expansion coefficient of the reflective layer, even if the temperature changes, the optical element is suppressed from being damaged or deformed to some extent. In JP 2016-21057 A, after the intermediate layer is provided on the substrate by plating or the like, a surface of the intermediate layer is shaped by cutting processing using a diamond tool, and a reflective layer is formed on the shaped intermediate layer. However, when the intermediate layer is shaped, there is a portion that is difficult to sufficiently shape because a movable range of the cutting tool or the like is limited. If an irregular portion remains on the surface of the intermediate layer, the shape accuracy of the reflective layer formed in that portion deteriorates. In addition, in a portion where the intermediate layer as a base is irregular, the surface shape of the reflective layer tends to locally change when the temperature changes.

### SUMMARY

Therefore, there has been a demand for an optical element and an optical system in which a reflecting face has high shape accuracy and a change in optical characteristics is small even when the temperature changes.

According to a first aspect of the present disclosure, an optical element includes a first face having a first reflecting region where a part of a light flux incident from a predetermined direction is reflected in a first direction, and a first non-optical region where the light flux is not incident, a second face having a second reflecting region where another part of the light flux incident from the predetermined direction is reflected in a second direction different from the first direction, and a third face connecting the first non-optical region and the second reflecting region. The first non-optical region and the third face form an acute angle outside the optical element. The second reflecting region and the third face form an acute angle inside the optical element.

According to a second aspect of the present disclosure, an optical system that splits an incident light flux, the optical system includes a slice mirror including a first face having a first reflecting region where a part of the light flux is reflected in a first direction, a second face having a second reflecting region where another part of the light flux is reflected in a second direction different from the first direction, and a third face connecting the first face and the second face. In the slice mirror, a region closer to the second face than the first reflecting region in the first face is hidden by a shadow of a portion defined by the second face and the third face, and is not irradiated with a light flux incident from a predetermined direction. The first reflecting region and the second reflecting region are arranged to be irradiated with the light flux incident from the predetermined direction.

Features of the present disclosure will become apparent from the following description of embodiments with reference to the attached drawings. The following description of embodiments is described by way of example.

### BRIEF DESCRIPTION OF THE DRAWINGS

FIG. 1 is a view for explaining an overall configuration of an optical device according to a first embodiment.

FIG. 2A is a schematic perspective view illustrating an appearance of a slice mirror according to a second embodiment.

FIG. 2B is a view in which a normal line NL is projected on a ZX face.

FIG. 2C is a view in which a normal line NL is projected on a ZY face.

FIG. 3 is a partial cross-sectional view of the slice mirror taken along line A1-A1 of FIG. 2A.

FIG. 4 is a view for explaining a region RR irradiated with incident light and a region NOP not irradiated with incident light.

FIG. 5 is a view for explaining reflected light reflected by the region RR.

FIG. 6 is a graph showing how much a surface shape of a face P changes when the slice mirror is cooled from room temperature to minus 196° C.

FIG. 7A is a schematic perspective view illustrating an appearance of a slice mirror according to a third embodiment.

FIG. 7B is a view in which a normal line NL is projected on a ZX face.

FIG. 7C is a view in which a normal line NL is projected on a ZY face.

FIG. 8 is a partial cross-sectional view of the slice mirror taken along line A3-A3 of FIG. 7A.

FIG. 9A is a schematic perspective view illustrating an appearance of a slice mirror according to a fourth embodiment.

FIG. 9B is a plan view of a face P2.

FIG. 9C is a plan view in which a region RR2 is distinguished from a region NOP2 (non-optical region) that is shaded by an eaves portion and is not irradiated with incident light.

FIG. 10A is a schematic perspective view illustrating an appearance of a slice mirror according to a fifth embodiment.

FIG. 10B is a plan view of a face P2.

FIG. 10C is a plan view in which a region RR2 is distinguished from a region NOP2 (non-optical region) that is shaded by an eaves portion and is not irradiated with incident light.

FIG. 11 is a view for explaining an internal structure of the slice mirror and a method for manufacturing the slice mirror.

FIG. 12A is a schematic perspective view illustrating an appearance of a slice mirror according to the first embodiment.

FIG. 12B is a view in which a normal line NL is projected on a ZX face.

FIG. 12C is a view in which a normal line NL is projected on a ZY face.

FIG. 13 is a partial cross-sectional view of the slice mirror taken along line B1-B1 of FIG. 12A, and is a view for explaining a region RR irradiated with incident light and a region NOP not irradiated with incident light.

FIG. 14 is a view for explaining reflected light reflected by the region RR.

### DESCRIPTION OF THE EMBODIMENTS

An optical system, an optical element, and an optical device, according to embodiments of the present disclosure will be described with reference to the drawings. The embodiments to be described below are examples, and for example, detailed configurations can be appropriately modified for implementation by those skilled in the art without departing from the scope of the invention as defined by the claims. Each of the embodiments of the present invention described below can be implemented solely or as a combination of a plurality of the embodiments or features thereof where necessary or where the combination of elements or features from individual embodiments is beneficial. A plurality of features are described in the embodiments, but not all the plurality of features are always essential to the invention. The plurality of features can also be arbitrarily combined.

Meanwhile, it should be noted that, in the drawings referred to in the following description of embodiments, elements denoted by the same reference numerals have the same functions unless otherwise specified. In the drawings, in a case where a plurality of identical elements is arranged, the reference numerals and explanations thereof may be omitted.

In addition, since the drawings may be schematically represented for convenience of illustration and description, shapes, sizes, arrangements etc. of elements illustrated in the drawings may not be exactly consistent with actual objects.

In the following description, for example, an X-plus direction refers to a direction indicated by an X-axis arrow in the illustrated coordinate system, and an X-minus direction refers to a direction 180-degree opposite to the direction indicated by the X-axis arrow in the illustrated coordinate system. In addition, when an X direction is simply mentioned, the X direction refers to a direction parallel to the X axis regardless of whether the X direction is different from the direction indicated by the illustrated X-axis arrow. The same applies to directions other than the X direction.

### First Embodiment

### Overall Configuration of Optical Device

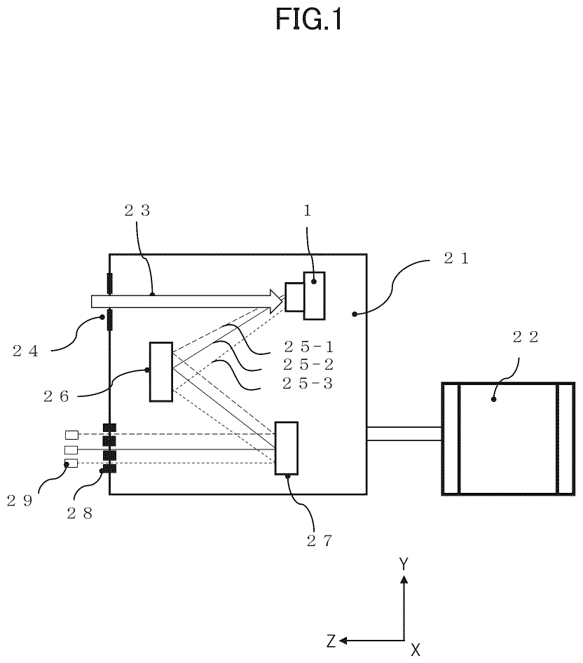

An overall configuration of an optical device according to a first embodiment will be described with reference to FIG. 1. An image slicer-type plane spectroscopic device 21 serving as an optical device includes an incidence slit 24, a slice mirror 1, a flat mirror array 26, a curved mirror array 27, an emission slit 28, and a light receiving sensor 29. The plane spectroscopic device 21 is preferably used for astronomical observation, but can be used for various application including public applications and industrial applications.

In a case where the plane spectroscopic device 21 is used for astronomical observation, incident light 23 (image, light flux) is incident on the plane spectroscopic device 21 from a telescope (not illustrated) through the incidence slit 24, and the incident light 23 travels in a Z-minus direction (predetermined direction) and reaches the slice mirror 1. A focal plane image of the telescope is split into a plurality of partial images by the slice mirror 1, and each partial image (split image, split light flux) is reflected in a different direction. The slice mirror 1 includes multiple reflecting planes, and the focal plane image of the telescope is split into multiple partial images and reflected in different directions. For convenience of illustration, three reflected light beams of reflected light 25-1, reflected light 25-2, and reflected light 25-3 are schematically illustrated in FIG. 1.

The reflected light beam corresponding to each partial image is reflected by a flat mirror constituting the flat mirror array 26, and an optical path is bent. By arranging the flat mirror array 26, the optical path space can be reduced, and the size of the spectroscopic device can be compact.

The light beam reflected by the flat mirror array 26 is reflected by each optical face of the curved mirror array 27 having a light collecting effect, passes through the emission slit 28, and is guided to the light receiving sensor 29.

Note that a pupil mirror and a slit mirror may be arranged instead of the flat mirror array 26, the curved mirror array 27, and the emission slit 28. The pupil mirror is a mirror for one-dimensionally rearranging the images split by the slice mirror. The slit mirror is a mirror for emitting the optical images rearranged by the pupil mirror in a slit shape toward the light receiving sensor.

The plane spectroscopic device 21 of the present embodiment is configured to be cooled by a cooling device 22 in order to reduce observation noise. As the cooling device 22, a device using liquid nitrogen, a device using liquid helium, or another device can be appropriately used depending on the desired cooling temperature.

For example, a semiconductor sensor is preferably used for the light receiving sensor 29, and is cooled by the cooling device 22 in order to reduce a dark current, which is a source of noise. The optimum temperature for the operation varies depending on the observation wavelength and the type of light receiving sensor. For example, it is desirable to cool the semiconductor sensor to 30 (K) to 80 (K) in a case where near-infrared light is observed, and to cool the semiconductor sensor to 6 (K) to 10 (K) in a case where mid-infrared light is observed.

Furthermore, in a case where an image to be observed includes, for example, light in the infrared region having a wavelength of 2 (μm) or more, infrared rays radiated from each optical element such as the slice mirror 1 and a structure such as the casing of the plane spectroscopic device 21 can be a source of noise, and thus, they are cooled by the cooling device 22. For example, the slice mirror 1 is cooled to 100 (K) or less in a case where near-infrared light is observed, and is cooled to 30 (K) or less in a case where mid-infrared light is observed. Furthermore, it may be desirable to cool the slice mirror 1 to about 4 (K).

### Configuration of Slice Mirror

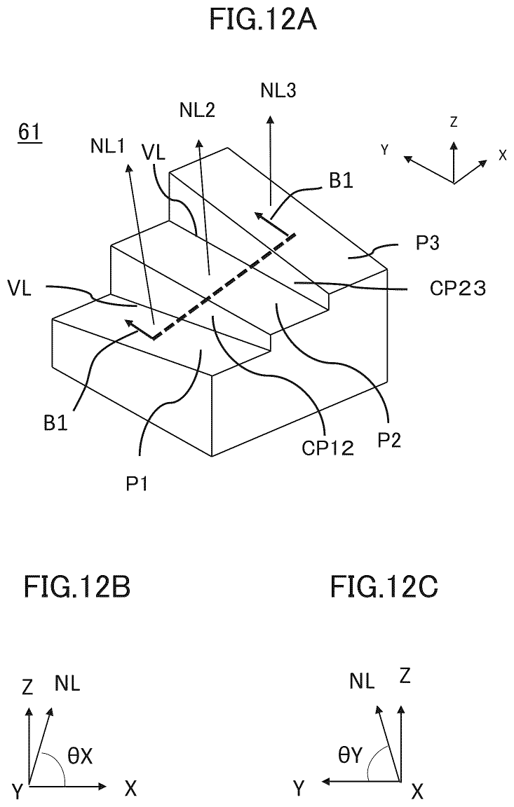

In the optical system or the optical device according to the first embodiment, a slice mirror 61 to be described below is mounted as the slice mirror 1 illustrated in FIG. 1. FIG. 12A is a schematic perspective view illustrating an appearance of the slice mirror 61. For convenience of illustration, the slice mirror 61 having three reflecting faces is illustrated, but the slice mirror 61 may have a greater number of reflecting faces.

In the slice mirror 61, a face P1, a face P2, and a face P3 are arranged at positions irradiated with the incident light 23 incident through the incidence slit 24 (FIG. 1). The face P1 and the face P2 are connected by a connection face CP12, and the face P2 and the face P3 are connected by a connection face CP23. In the following description, when the slice mirror 61 is mounted on the optical device illustrated in FIG. 1, a portion defined by the connection face CP12 and the face P2 and protruding in the X-minus direction and a portion defined by the connection face CP23 and the face P3 and protruding in the X-minus direction may be referred to as eaves portions.

As will be described below, each of the face P1, the face P2, and the face P3 includes a reflecting region (also referred to as an optical region) that reflects the incident light 23 incident along the Z-minus direction, and a non-optical region that is hidden by the shadow of the eaves portion, is not irradiated with the incident light 23, and does not function as a reflecting region. In FIG. 12A, a normal line passing through the center of gravity of the reflecting region (optical region) included in the face P1 and perpendicular to the face P1 is shown as NL1, and a normal line passing through the center of gravity of the reflecting region (optical region) included in the face P2 and perpendicular to the face P2 is shown as NL2. Similarly, a normal line passing through the center of gravity of the reflecting region (optical region) included in the face P3 and perpendicular to the face P3 is shown as NL3.

Since the face P1, the face P2, and the face P3 split the focal plane image of the telescope into partial images and reflect the partial images in different directions, NL1, NL2, and NL3 face in different directions. That is, NL1, NL2, and NL3 are not parallel to each other. When an angle formed by the normal line NL with the X axis when the normal line NL is projected on the ZX plane is defined as OX as illustrated in FIG. 12B and an angle formed by the normal line NL with the Y axis when the normal line NL is projected on the ZY plane is defined as OY as illustrated in FIG. 12C, OX of NL1, 0X of NL2, and OX of NL3 are different from each other, and OY of NL1, OY of NL2, and OY of NL3 are different from each other.

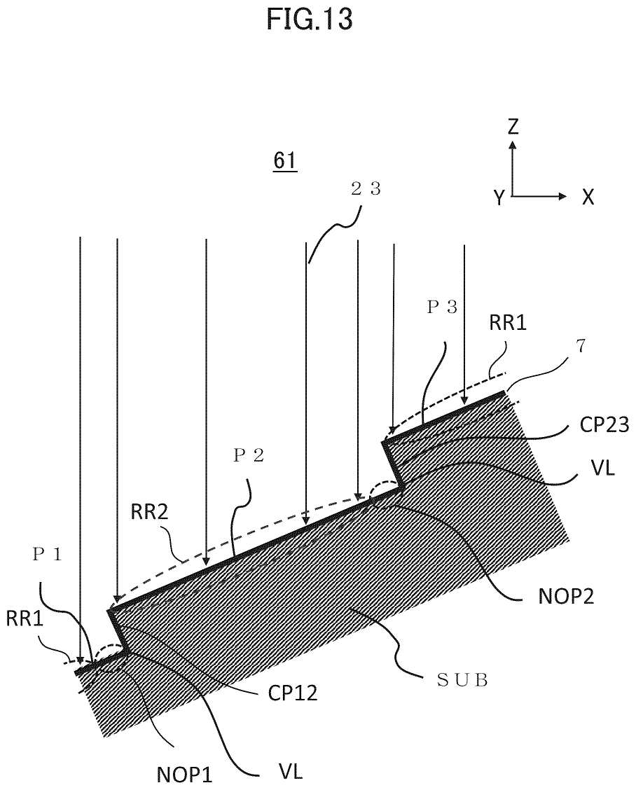

FIG. 13 illustrates a partial cross-sectional view of the slice mirror 61 taken along line B1-B1 of FIG. 12A. FIG. 13 is a schematic view for explaining that the slice mirror 61 is arranged to generate a region RR irradiated with the incident light 23 and a region NOP not irradiated with the incident light 23 when the incident light 23 is incident on the slice mirror 61 along the Z-minus direction.

As a result of arranging the slice mirror 61 as illustrated in FIG. 13, a region RR1 of the face P1, a region RR2 of the face P2, and a region RR3 of the face P3 are irradiated with the incident light 23. On the other hand, a region NOP1 of the face P1 and a region NOP2 of the face P2 are hidden by the shadow of the eaves portion protruding in the X-minus direction, and thus are not irradiated with the incident light 23 incident along the Z-minus direction. In other words, it can be said that the region RR1, the region RR2, and the region RR3 function as reflecting regions (optical regions) that reflect the incident light 23, and the region NOP1 and the region NOP2 are non-optical regions that do not function as reflecting regions because they are not irradiated with the incident light 23.

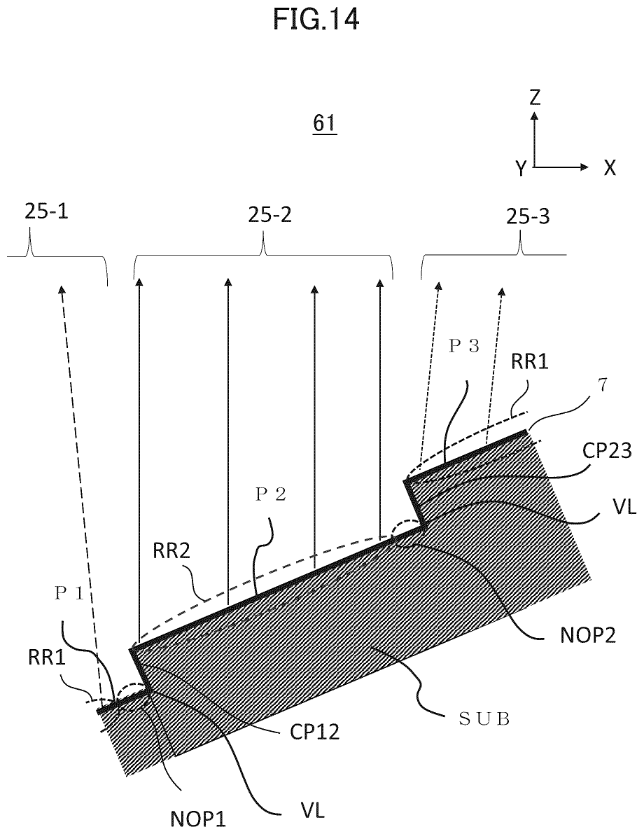

FIG. 14 illustrates reflected light 25-1 obtained by reflecting the incident light 23 incident on the region RR1 of the face P1, reflected light 25-2 obtained by reflecting the incident light 23 incident on the region RR2 of the face P2, and reflected light 25-3 obtained by reflecting the incident light 23 incident on the region RR3 of the face P3. As described with reference to FIGS. 12A to 12C, since the faces P1 to P3 are not parallel to each other, the incident light 23 is split and reflected, traveling in different directions. That is, the reflected light 25-1, the reflected light 25-2, and the reflected light 25-3 are reflected toward individual flat mirrors constituting the flat mirror array 26 (FIG. 1). The optical axes of the reflected light 25-1 to the reflected light 25-3 are not parallel to each other when projected on the X-Z plane or the Y-Z plane.

### Method for Manufacturing Slice Mirror

Next, an internal structure of the slice mirror 61, which is an optical element, and a method for manufacturing the slice mirror 61 will be described with reference to FIGS. 13 and 14. An alloy material having a low thermal expansion coefficient, for example, invar having a thermal expansion coefficient of 0.03 (ppm) at −196 (° C.), can be used for a substrate SUB that is a base of the slice mirror 61. As the substrate SUB, instead of invar, any material selected from a group of low thermal expansion coefficient materials such as pre-hardened steel obtained by heat-treating martensitic stainless steel SUS420J2, quartz, glass, and ceramics can be used. Specific examples include STAVAX (registered trademark), which is martensitic stainless steel, BK7, which is optical glass, ULE (registered trademark), ZERODUR (registered trademark), Clearcellam (registered trademark).

For example, the substrate SUB of the slice mirror 61 is manufactured from a bulk invar material using a machining method such as cutting or wire electric discharge machining. Note that it is desirable to process a portion used as a positional reference when the slice mirror 61 is installed in the plane spectroscopic device 21, for example, a corner portion serving as an abutment reference, to have flatness and orthogonality with high accuracy.

Next, a metal film 7 is formed at least at portions that will be the face P1 to the face P3. The metal film 7 is desirably made of a material that is easily mirror-finished after film formation, and for example, an electrolytic plating film containing copper as a main component can be used. Specifically, a dense layered film can be formed by copper sulfate plating, which is a wet process. The metal film 7 is formed at least at portions that will be the face P1 to the face P3, but in order to ensure adhesion to the substrate SUB and shape stability, it is desirable that the coating is continuously formed on the connection face CP12 and the connection face CP23 as well.

The metal film 7 is formed to have a thickness sufficient for performing mirror finishing. In addition, the metal film 7 is formed to have a sufficient thickness so that cracks and film peeling do not occur even when the slice mirror 61 is cooled by the cooling device 22 (FIG. 1). Specifically, for example, the metal film 7 is formed to have a thickness of 10 (μm) or more and 3000 (μm) or less, preferably 50 (μm) or more and 300 (μm) or less.

Next, the metal film 7 is subjected to precision cutting so as to improve the flatness of the regions irradiated with the incident light 23, that is, the regions RR1 to RR3 of the faces P1 to P3. For example, using a diamond tool having a cutting edge, smooth mirror faces having a surface roughness Ra of about 1 (nm) are formed in portions that will be the region RR1 to the region RR3. Note that portions not to be irradiated with the incident light 23, that is, the regions NOP1 and NOP2 and the connection faces CP12 and CP23, do not necessarily need to be mirror-finished. However, in order to stably mirror-finish the regions RR1 to RR3 or to improve the adhesion of the reflective film to be described below, the portions not to be irradiated with the incident light 23 may also be mirror-finished.

Next, the regions to be irradiated with the incident light 23, that is, the surfaces of the regions RR1 to RR3 of the faces P1 to P3, are covered with reflective films (not illustrated) having a high reflectance in the wavelength range to be observed. The reflective film faithfully follows the mirror-polished base shape to sufficiently reflect light to be observed, and the thickness of the reflective film is appropriately set so that the film can be formed with a uniform thickness, for example, to 40 (nm). As the reflective film, for example, a metal film such as aluminum or gold, a dielectric multilayer film, or the like can be formed.

By using a film forming method such as directional deposition or directional sputtering in which a material beam is emitted from the same direction as the incident light 23 illustrated in FIG. 13, reflective films can be formed only on the surfaces of the regions RR1 to RR3. Alternatively, films may be formed in the regions NOP1 and NOP2 and the connection faces CP12 and CP23, as well as the regions RR1 to RR3, by using a film forming method with no directionality such as sputtering, deposition, or CVD. The films in these portions do not function as optical films because they are not irradiated with the incident light 23, but can enhance the ability to prevent the reflective films from being peeled off, for example, against a temperature change because they are formed integrally with the reflective films formed in the regions RR1 to RR3.

### Advantages of Slice Mirror According to Embodiment

Advantages of mounting the slice mirror 61 according to the present embodiment on the face spectroscopic device 21 will be described. In the process of manufacturing the slice mirror 61, when the surface of the region NOP located in the vicinity of the intersection line where the face P and the connection face CP intersect is machined, the machining accuracy tends to be lower than when the surface of the region RR is machined, for example, for the reason that the degree of freedom of movement of the cutting edge of the cutting tool is limited. According to the present embodiment, the slice mirror 61 is arranged such that the region RR having a high surface shape accuracy is a reflecting face (also referred to as an optical face) and the region NOP having a low surface shape accuracy is a non-optical region. The face spectroscopic device 21 on which the slice mirror 61 having highly accurate reflecting faces is mounted can exhibit high spectroscopic accuracy.

Furthermore, as described above, the plane spectroscopic device 21 can be cooled by the cooling device 22. For example, when the slice mirror 61 is cooled from room temperature to a temperature condition suitable for observation of infrared light, the shape of each portion changes due to contraction. Since the substrate constituting the slice mirror 61, the metal film formed on the substrate, and the reflective film formed on the metal film have different linear expansion coefficients, the surface shape of the face P changes when the slice mirror 61 is cooled.

On the surface of the region RR of the face P, even if a temperature change occurs, the deformation amount in the Z direction is small, and the flatness is maintained at a high level, so that the incident light 23 can be reflected in a predetermined direction. On the other hand, on the surface of the region NOP, the deformation amount in the Z direction is large, and the surface is inclined. Although the reason why the deformation amount is large in the region NOP has not been clearly elucidated, it is considered that this is because stress caused by thermal deformation tends to concentrate in the vicinity of the line (valley line VL) where the face P and the connection face CP intersect.

If the region NOP where the surface is inclined is irradiated with incident light, the incident light is reflected in an unintended direction. However, the slice mirror 61 according to the embodiment is arranged (configured) such that the region NOP (the regions NOP1 and NOP2), where the surface is inclined, is shaded by an eaves portion, and is not irradiated with the incident light 23. Therefore, the incident light 23 is not reflected in an unintended direction (that is, in a direction different from a predetermined flat mirror of the flat mirror array 26). That is, the slice mirror 61 according to the embodiment has an advantage in that the reflecting region is maintained with high shape accuracy even when the temperature changes, and the change in optical characteristics is small. The plane spectroscopic device 21 including the slice mirror 61, which changes the optical path of reflected light little even when cooled, can achieve high spectroscopic accuracy.

### Second Embodiment

In an optical system or an optical device according to the second embodiment, a slice mirror 1 to be described below is mounted as the slice mirror 1 illustrated in FIG. 1. As will be described below, the slice mirror 1 according to the present embodiment is characterized in an angle formed by the connection face CP and the face P.

### Configuration of Slice Mirror

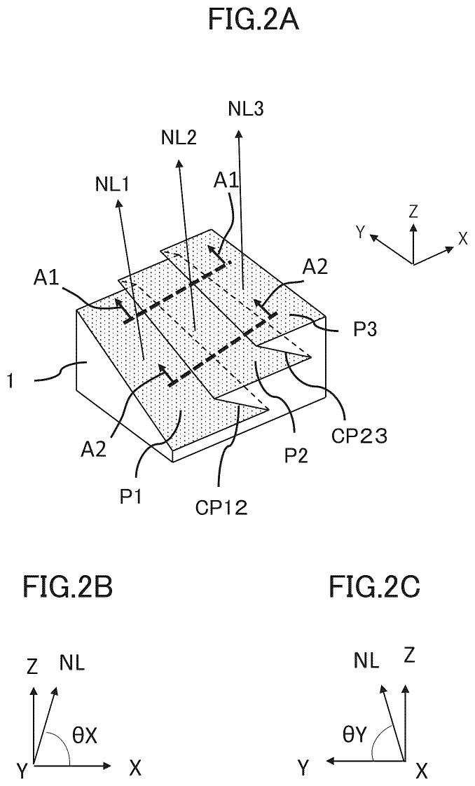

Next, the slice mirror 1 that is an optical element according to the second embodiment will be described. FIG. 2A is a schematic perspective view illustrating an appearance of the slice mirror 1. For convenience of illustration, the slice mirror 1 having three reflecting faces is illustrated, but the slice mirror 1 may have a greater number of reflecting faces.

In the slice mirror 1, a face P1, a face P2, and a face P3 are arranged at positions irradiated with the incident light 23 incident through the incidence slit 24 (FIG. 1). The face P1 and the face P2 are connected by a connection face CP12, and the face P2 and the face P3 are connected by a connection face CP23. In the following description, a portion including the connection face CP12 and protruding in the X-minus direction and a portion including the connection face CP23 and protruding in the X-minus direction may be referred to as eaves portions.

As will be described below, each of the face P1, the face P2, and the face P3 includes a reflecting region (optical region) that reflects the incident light 23 incident along the Z-minus direction, and a non-optical region that is not irradiated with the incident light 23, and does not function as a reflecting region. In FIG. 2A, a normal line passing through the center of gravity of the reflecting region (optical region) included in the face P1 and perpendicular to the face P1 is shown as NL1, and a normal line passing through the center of gravity of the reflecting region (optical region) included in the face P2 and perpendicular to the face P2 is shown as NL2. Similarly, a normal line passing through the center of gravity of the reflecting region (optical region) included in the face P3 and perpendicular to the face P3 is shown as NL3.

Since the face P1, the face P2, and the face P3 split the focal face image of the telescope into partial images and reflect the partial images in different directions, NL1, NL2, and NL3 face in different directions. That is, NL1, NL2, and NL3 are not parallel to each other. When an angle formed by the normal line NL with the X axis when the normal line NL is projected on the ZX plane is defined as OX as illustrated in FIG. 2B and an angle formed by the normal line NL with the Y axis when the normal line NL is projected on the ZY plane is defined as OY as illustrated in FIG. 2C, OX of NL1, 0X of NL2, and 0X of NL3 are different from each other, and OY of NL1, OY of NL2, and OY of NL3 are different from each other.

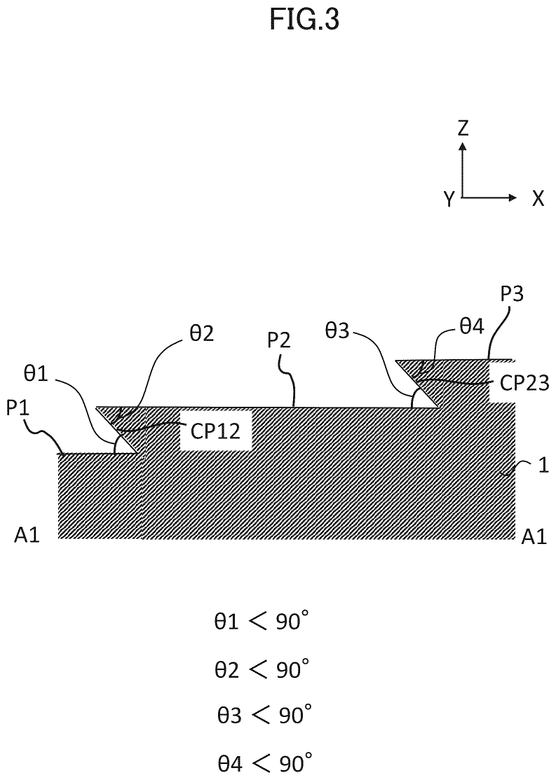

FIG. 3 is a partial cross-sectional view of the slice mirror 1 taken along line A1-A1 of FIG. 2A. An angle formed by the face P1 and the connection face CP12 is defined as θ1 outside the slice mirror 1, and an angle formed by the connection face CP12 and the face P2 is defined as θ2 inside the slice mirror 1. In addition, an angle formed by the face P2 and the connection face CP23 is defined as θ3 outside the slice mirror 1, and an angle formed by the connection face CP23 and the face P3 is defined as θ4 inside the slice mirror 1.

In the slice mirror 1 according to the present embodiment, all of θ1, θ2, θ3, and θ4 are acute angles smaller than 90 degrees (θ1<90°, θ2<90°, θ3<90°, θ4<90°). Although FIG. 3 illustrates a cross section taken along line A1-A1 of FIG. 2A, all of θ1, θ2, θ3, and θ4 are acute angles smaller than 90 degrees even in a cross section of the slice mirror 61 taken at another position such as line A2-A2. Even when the slice mirror 1 has more than three faces at positions irradiated with the incident light 23 (FIG. 1), an angle formed by each face and a connection face is similarly an acute angle.

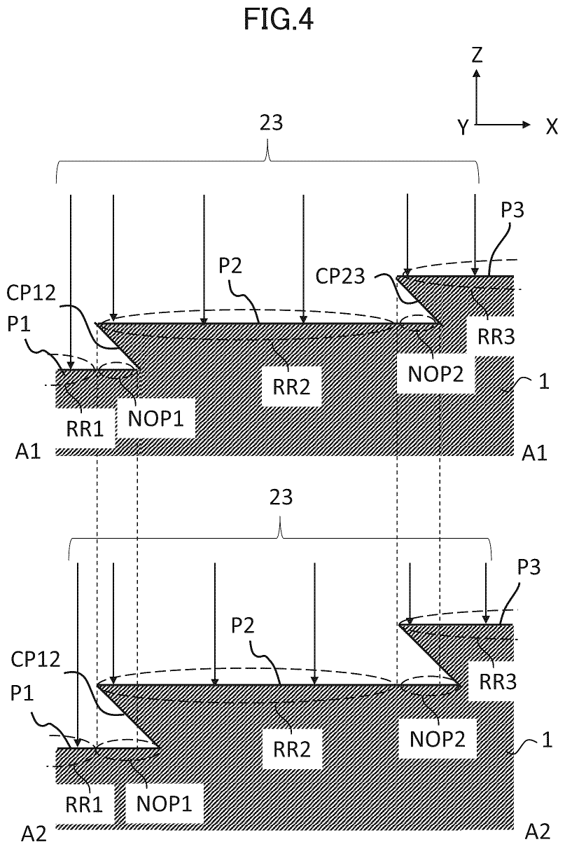

FIG. 4 is a schematic view for explaining that the slice mirror 1 is configured to generate a region RR irradiated with the incident light 23 and a region NOP not irradiated with the incident light 23 when the incident light 23 is incident on the slice mirror 1 along the Z-minus direction. In FIG. 4, a partial cross section taken along line A1-A1 of FIG. 1 is illustrated on the upper side, and a partial cross section taken along line A2-A2 of FIG. 1 is illustrated on the lower side.

As described with reference to FIG. 3, since 01 to 04 are acute angles smaller than 90 degrees, the region RR1 of the face P1, the region RR2 of the face P2, and the region RR3 of the face P3 are irradiated with the incident light 23. On the other hand, since the region NOP1 of the face P1 and the region NOP2 of the face P2 are shadows of eaves portions protruding in the X-minus direction, they are not irradiated with the incident light 23 incident along the Z-minus direction. In other words, it can be said that the region RR1, the region RR2, and the region RR3 function as reflecting regions (optical regions) that reflect the incident light 23, and the region NOP1 and the region NOP2 are non-optical regions that do not function as reflecting regions because they are not irradiated with the incident light 23.

Since the faces P1 to P3 are not parallel to each other as described with reference to FIGS. 2A to 2C, the widths of the region NOP1 and the region NOP2 in the X direction are different depending on the cut surface as illustrated in FIG. 4. That is, the shape of each of the region NOP1 and the region NOP2 serving as a non-optical region changes width in the lateral direction along the longitudinal direction.

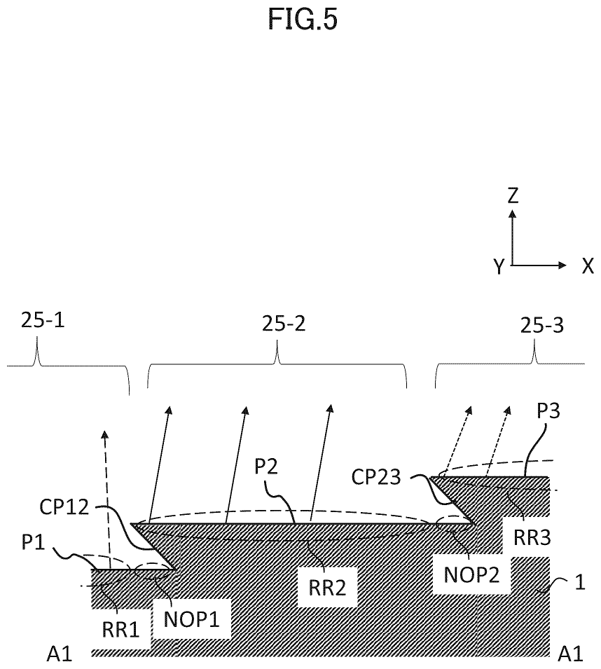

FIG. 5 illustrates reflected light 25-1 obtained by reflecting the incident light 23 incident on the region RR1 of the face P1, reflected light 25-2 obtained by reflecting the incident light 23 incident on the region RR2 of the face P2, and reflected light 25-3 obtained by reflecting the incident light 23 incident on the region RR3 of the face P3. As described with reference to FIGS. 2A to 2C, since the faces P1 to P3 are not parallel to each other, the incident light 23 is split and reflected, traveling in different directions. That is, the reflected light 25-1, the reflected light 25-2, and the reflected light 25-3 are reflected toward individual flat mirrors constituting the flat mirror array 26 (FIG. 1). The optical axes of the reflected light 25-1 to the reflected light 25-3 are not parallel to each other when projected on the X-Z plane or the Y-Z plane.

### Method for Manufacturing Slice Mirror

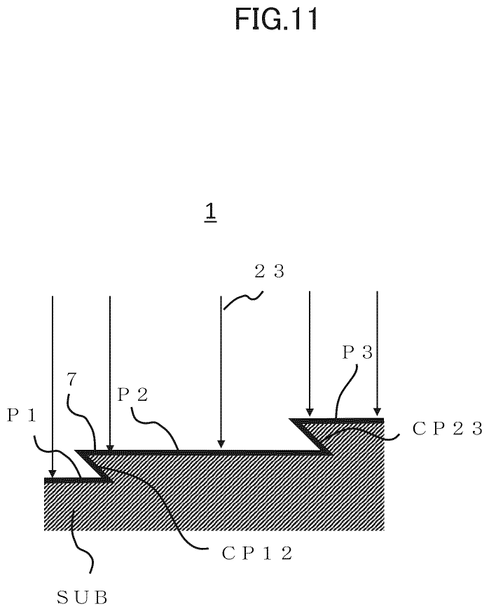

Next, an internal structure of the slice mirror 1, which is an optical element, and a method for manufacturing the slice mirror 1 will be described with reference to FIG. 11. An alloy material having a low thermal expansion coefficient, for example, invar having a thermal expansion coefficient of 0.03 (ppm) at −196° C., can be used for a substrate SUB that is a base of the slice mirror 1. As the substrate SUB, instead of invar, any material selected from a group of low thermal expansion coefficient materials such as pre-hardened steel obtained by heat-treating martensitic stainless steel SUS420J2, quartz, glass, and ceramics can be used. Specific examples include STAVAX (registered trademark), which is martensitic stainless steel, BK7, which is optical glass, ULE (registered trademark), ZERODUR (registered trademark), Clearcellam (registered trademark).

For example, the substrate SUB of the slice mirror 1 is manufactured from a bulk invar material using a machining method such as cutting or wire electric discharge machining. Note that it is desirable to process a portion used as a positional reference when the slice mirror 61 is installed in the plane spectroscopic device 21, for example, a corner portion serving as an abutment reference, to have flatness and orthogonality with high accuracy.

Next, a metal film 7 is formed at least at portions that will be the face P1 to the face P3. The metal film 7 is desirably made of a material that is easily mirror-finished after film formation, and for example, an electrolytic plating film containing copper as a main component can be used. Specifically, a dense layered film can be formed by copper sulfate plating, which is a wet process. The metal film 7 is formed at least at portions that will be the face P1 to the face P3, but in order to ensure adhesion to the substrate SUB and shape stability, it is desirable that the coating is continuously formed on the connection face CP12 and the connection face CP23 as well.

The metal film 7 is formed to have a thickness sufficient for performing mirror finishing. In addition, the metal film 7 is formed to have a sufficient thickness so that cracks and film peeling do not occur even when the slice mirror 1 is cooled by the cooling device 22 (FIG. 1). Specifically, for example, the metal film 7 is formed to have a thickness of 10 (μm) or more and 3000 (μm) or less, preferably 50 (μm) or more and 300 (μm) or less.

Next, the metal film 7 is subjected to precision cutting so as to improve the flatness of the regions irradiated with the incident light 23, that is, the regions RR1 to RR3 of the faces P1 to P3. For example, using a diamond tool having a cutting edge, smooth mirror faces having a surface roughness Ra of about 1 (nm) are formed in portions that will be the region RR1 to the region RR3. Note that portions not to be irradiated with the incident light 23, that is, the regions NOP1 and NOP2 and the connection faces CP12 and CP23, do not necessarily need to be mirror-finished. However, in order to stably mirror-finish the regions RR1 to RR3 or to improve the adhesion of the reflective film to be described below, the portions not to be irradiated with the incident light 23 may also be mirror-finished.

Next, the regions to be irradiated with the incident light 23, that is, the surfaces of the regions RR1 to RR3 of the faces P1 to P3, are covered with reflective films (not illustrated) having a high reflectance in the wavelength range to be observed. The reflective film faithfully follows the mirror-polished base shape to sufficiently reflect light to be observed, and the thickness of the reflective film is appropriately set so that the film can be formed with a uniform thickness, for example, to 40 (nm). As the reflective film, for example, a metal film such as aluminum, gold, silver, or the like, a dielectric multilayer film, or the like can be formed.

By using a film forming method such as directional deposition or directional sputtering in which a material beam is emitted from the same direction as the incident light 23 illustrated in FIG. 4, reflective films can be formed only on the surfaces of the regions RR1 to RR3. Alternatively, films may be formed in the regions NOP1 and NOP2 and the connection faces CP12 and CP23, as well as the regions RR1 to RR3, by using a film forming method with no directionality such as sputtering, deposition, or CVD. The films in these portions do not function as optical films because they are not irradiated with the incident light 23, but can enhance the ability to prevent the reflective films from being peeled off, for example, against a temperature change because they are formed integrally with the reflective films formed in the regions RR1 to RR3.

### Advantages of Slice Mirror According to Embodiment

Advantages of mounting the slice mirror 1 according to the present embodiment on the plane spectroscopic device 21 will be described. In the process of manufacturing the slice mirror 1, when the surface of the region NOP located in the vicinity of the intersection line where the face P and the connection face CP intersect is machined, the machining accuracy tends to be lower than when the surface of the region RR is machined, for example, for the reason that the degree of freedom of movement of the cutting edge of the cutting tool is limited. According to the present embodiment, the region RR having a high surface shape accuracy is set as a reflecting face (optical face) and the region NOP having a low surface shape accuracy is set as a non-optical region. The plane spectroscopic device 21 on which the slice mirror 1 having highly accurate reflecting faces is mounted can exhibit high spectroscopic accuracy.

Furthermore, as described above, the face spectroscopic device 21 can be cooled by the cooling device 22. For example, when the slice mirror 1 is cooled from room temperature to a temperature condition suitable for observation of infrared light, the shape of each portion changes due to contraction. Since the substrate constituting the slice mirror 1, the metal film formed on the substrate, and the reflective film formed on the metal film have different linear expansion coefficients, the surface shape of the face P changes when the slice mirror 1 is cooled.

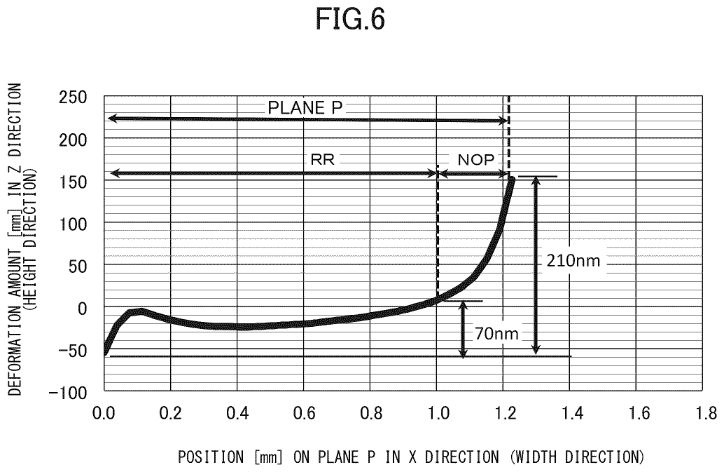

FIG. 6 is a graph illustrating how much the surface shape changes at each position of the face P when the slice mirror 1 is cooled from room temperature to minus 196° C. by the cooling device 22 using liquid nitrogen. The horizontal axis in FIG. 6 indicates a position on the face P of the slice mirror 1 in the left-right direction (X direction) when viewed from the same direction as in FIG. 4, and the vertical axis in FIG. 6 indicates a deformation amount of the face P in the traveling direction (Z direction) of the incident light 23.

The specifications of the slice mirror from which the measurement result of FIG. 6 is observed are as follows. The slice mirror has an outer size of 29 (mm)×35.5 (mm) in plan view, and a maximum height of 40 (mm) in the Z direction. The slice mirror has 29 faces P, the width of the region RR of each face P in the X direction is 1 (mm), and adjacent ones of the faces P are arranged to be shifted from each other by 0.2 (mm) in the Z direction. The substrate SUB is an invar material having a thermal expansion coefficient of −0.03 (ppm/K). The face P and the connection face CP are coated with a copper sulfate plating having a thickness of 0.05 (mm) and a thermal expansion coefficient of 17.7 (ppm/K) as a metal film. θ1, θ2, θ3, and θ4 described with reference to FIG. 3 are all set to 45°. Note that the 29 faces P have the same angle setting.

In the region RR irradiated with the incident light 23 incident from the Z direction, as illustrated in FIG. 6, the deformation amount in the Z direction is about 70 (nm) at the maximum, and the flatness is maintained at a high level, so that the incident light 23 can be reflected in a predetermined direction. On the other hand, in the region NOP, as illustrated in FIG. 6, the deformation amount in the Z direction reaches about 210 (nm) at the maximum, and the surface is inclined. Although the reason why the deformation amount is large in the region NOP has not been clearly elucidated, it is considered that this is because stress caused by thermal deformation tends to concentrate in the vicinity of the line (valley line) where the face P and the connection face CP intersect.

If the region NOP where the surface is inclined is irradiated with incident light, the incident light is reflected in an unintended direction. However, the slice mirror 1 according to the embodiment is configured such that the region NOP (the regions NOP1 and NOP2), where the surface is inclined, is shaded by an eaves portion, and is not irradiated with the incident light 23. Therefore, the incident light 23 is not reflected in an unintended direction (that is, in a direction different from a predetermined flat mirror of the flat mirror array 26). That is, the slice mirror 1 according to the embodiment has an advantage in that the reflecting region is maintained with high shape accuracy even when the temperature changes, and the change in optical characteristics is small. The plane spectroscopic device 21 including the slice mirror 1, which changes the optical path of reflected light little even when cooled, can achieve high spectroscopic accuracy.

### Third Embodiment

In the slice mirror 1 according to the first embodiment or the second embodiment, the region RR functioning as a reflecting face is formed to have a flat surface, but the embodiments of the present disclosure are not limited to this example. As a third embodiment, an example of a slice mirror in which the region RR functioning as a reflecting face is formed to have a curved surface will be described. In an optical system or an optical device according to the third embodiment, a slice mirror 31 to be described below is mounted as the slice mirror 1 illustrated in FIG. 1. Explanations of matters similar to those in the first and second embodiments will be simplified or omitted.

### Configuration of Slice Mirror

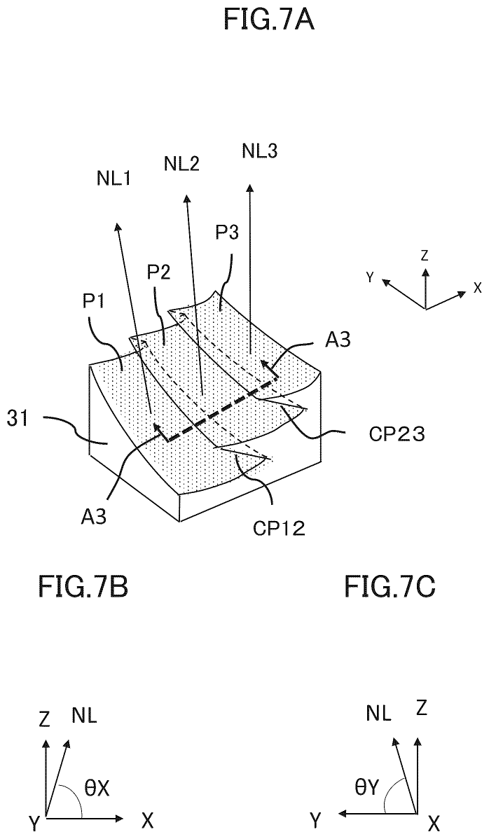

The slice mirror 31 that is an optical element according to the third embodiment will be described. FIG. 7A is a schematic perspective view illustrating an appearance of the slice mirror 31. For convenience of illustration, the slice mirror 31 having three reflecting faces is illustrated, but the slice mirror 31 may have a greater number of reflecting faces.

In the slice mirror 31, a face P1, a face P2, and a face P3 are arranged at positions irradiated with the incident light 23 incident through the incidence slit 24 (FIG. 1). The face P1 and the face P2 are connected by a connection face CP12, and the face P2 and the face P3 are connected by a connection face CP23. In the following description, a portion including the connection face CP12 and protruding in the X-minus direction and a portion including the connection face CP23 and protruding in the X-minus direction may be referred to as eaves portions.

Similarly to the first embodiment, each of the face P1, the face P2, and the face P3 includes a reflecting region (optical region) that reflects the incident light 23 incident along the Z-minus direction, and a non-optical region that does not function as a reflecting region because it is not irradiated with the incident light 23. In FIG. 7A, a normal line passing through the center of gravity of the reflecting region (optical region) included in the face P1 and perpendicular to the face P1 is shown as NL1, and a normal line passing through the center of gravity of the reflecting region (optical region) included in the face P2 and perpendicular to the face P2 is shown as NL2. Similarly, a normal line passing through the center of gravity of the reflecting region (optical region) included in the face P3 and perpendicular to the face P3 is shown as NL3.

Since the face P1, the face P2, and the face P3 split the focal plane image of the telescope into partial images and reflect the partial images in different directions, NL1, NL2, and NL3 face in different directions. When an angle formed by the normal line NL with the X axis when the normal line NL is projected on the ZX plane is defined as OX as illustrated in FIG. 7B and an angle formed by the normal line NL with the Y axis when the normal line NL is projected on the ZY plane is defined as OY as illustrated in FIG. 7C, OX of NL1, 0X of NL2, and OX of NL3 are different from each other, and OY of NL1, OY of NL2, and OY of NL3 are different from each other.

In addition, each of the face P1, the face P2, and the face P3 has a curved surface (concave surface) shape in order to condense the focal plane image of the telescope split into the partial images at predetermined positions different from each other. That is, the region RR (optical region) included in each of the face P1, the face P2, and the face P3 is formed in a curved surface shape to function as a concave mirror.

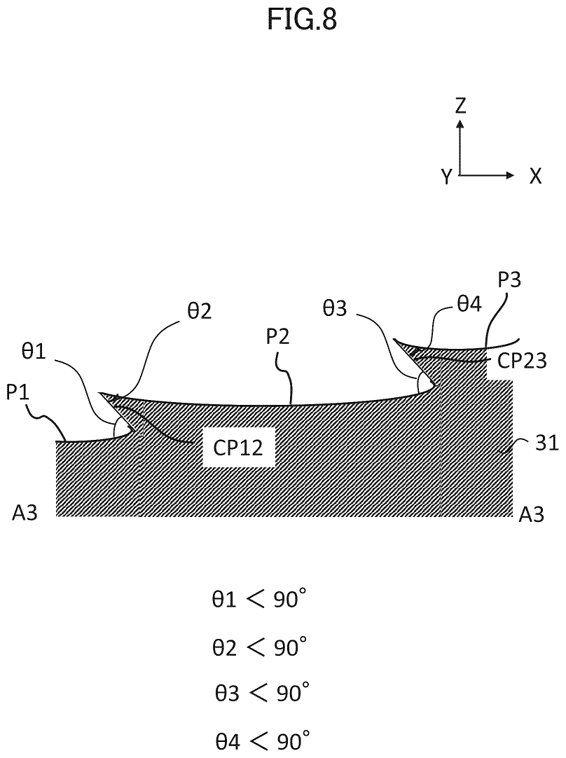

FIG. 8 is a partial cross-sectional view of the slice mirror 31 taken along line A3-A3 of FIG. 7A. An angle formed by the face P1 and the connection face CP12 is defined as θ1 outside the slice mirror 31, and an angle formed by the connection face CP12 and the face P2 is defined as θ2 inside the slice mirror 31. In addition, an angle formed by the face P2 and the connection face CP23 is defined as θ3 outside the slice mirror 31, and an angle formed by the connection face CP23 and the face P3 is defined as θ4 inside the slice mirror 31.

In the slice mirror 31 according to the present embodiment, all of θ1, θ2, θ3, and θ4 are acute angles smaller than 90 degrees (θ1<90°, θ2<90°, θ3<90°, θ4<90°). Although FIG. 8 illustrates a cross section taken along line A3-A3 of FIG. 7A, all of θ1, θ2, θ3, and θ4 are acute angles smaller than 90 degrees, for example, even in a cross section taken at another position. Even when the slice mirror 31 has more than three faces at positions irradiated with the incident light 23 (FIG. 1), an angle formed by each face and a connection face is similarly an acute angle.

In the present embodiment, similarly to the first and second embodiments, the region RR having a high surface shape accuracy is set as a reflecting face (optical face) and the region NOP having a low surface shape accuracy is set as a non-optical region. Therefore, the plane spectroscopic device 21 including the slice mirror 31 can exhibit high spectroscopic accuracy.

In addition, similarly to the first embodiment and second embodiment, the slice mirror 31 according to the present embodiment has an advantage in that the reflecting region is maintained with high shape accuracy even when the temperature changes, and the change in optical characteristics is small. The plane spectroscopic device 21 including the slice mirror 31, which changes the optical path of reflected light little even when cooled, can achieve high spectroscopic accuracy.

### Fourth Embodiment

In the slice mirror 1 according to the first embodiment or the second embodiment, the shape of the face P including the region RR functioning as a reflecting plane is rectangular in plan view from the direction (Z direction) of the incident light 23, but the embodiments of the present disclosure are not limited to this example. As a fourth embodiment, an example of a slice mirror in which the shape of the face P including the region RR functioning as a reflecting face is trapezoidal in plan view from the direction (Z direction) of the incident light will be described. In an optical system or an optical device according to the fourth embodiment, a slice mirror 41 to be described below is mounted as the slice mirror 1 illustrated in FIG. 1. Explanations of matters similar to those in the first and second embodiments will be simplified or omitted.

### Configuration of Slice Mirror

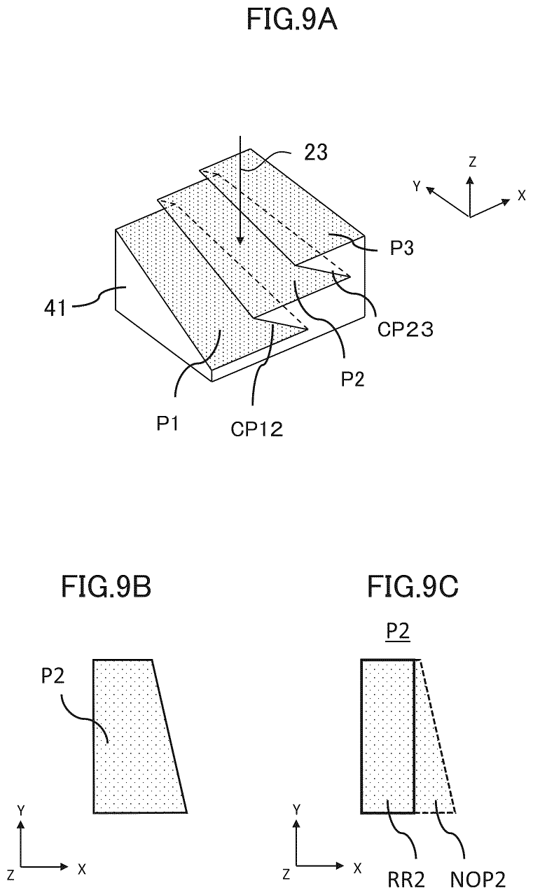

The slice mirror 41 that is an optical element according to the fourth embodiment will be described. FIG. 9A is a schematic perspective view illustrating an appearance of the slice mirror 41. For convenience of illustration, the slice mirror 41 having three reflecting faces is illustrated, but the slice mirror 41 may have a greater number of reflecting faces.

In the slice mirror 41, a face P1, a face P2, and a face P3 are arranged at positions irradiated with the incident light 23 incident through the incidence slit 24 (FIG. 1). The face P1 and the face P2 are connected by a connection face CP12, and the face P2 and the face P3 are connected by a connection face CP23. In the following description, a portion including the connection face CP12 and protruding in the X-minus direction and a portion including the connection face CP23 and protruding in the X-minus direction may be referred to as eaves portions.

Similarly to the first and second embodiments, each of the face P1, the face P2, and the face P3 includes a reflecting region (optical region) that reflects the incident light 23 incident along the Z-minus direction, and a non-optical region that does not function as a reflecting region because it is not irradiated with the incident light 23.

FIG. 9B is a plan view of the face P2 viewed from the direction (Z direction) of the incident light. As illustrated, the face P2 has a trapezoidal shape. FIG. 9C illustrates a plan view of the face P2 in which the region RR2 functioning as a reflecting face is distinguished from the region NOP2 (non-optical region) that is shaded by the eaves portion and is not irradiated with the incident light 23. It can be seen that, while the region RR2 functioning as a reflecting face is rectangular, the width in the lateral direction (X direction) of the region NOP2 (non-optical region) changes along the longitudinal direction (Y direction) of the face P2. In FIGS. 9B and 9C, the face P2 is exemplified, but the face P1 and the face P3 are similarly formed.

In the present embodiment, similarly to the first and second embodiments, the region RR having a high surface shape accuracy is set as a reflecting face (optical face) and the region NOP having a low surface shape accuracy is set as a non-optical region. Therefore, the plane spectroscopic device 21 including the slice mirror 41 can exhibit high spectroscopic accuracy.

In addition, similarly to the first embodiment and second embodiment, the slice mirror 41 according to the present embodiment has an advantage in that the reflecting region is maintained with high shape accuracy even when the temperature changes, and the change in optical characteristics is small. The plane spectroscopic device 21 including the slice mirror 41, which changes the optical path of reflected light little even when cooled, can achieve high spectroscopic accuracy.

### Fifth Embodiment

As a fifth embodiment, an example of a slice mirror in which the shape of the face P including the region RR functioning as a reflecting face is hexagonal in plan view from the direction (Z direction) of the incident light will be described. In an optical system or an optical device according to the fifth embodiment, a slice mirror 51 to be described below is mounted as the slice mirror 1 illustrated in FIG. 1. Explanations of matters similar to those in the first and second embodiments will be simplified or omitted.

### Configuration of Slice Mirror

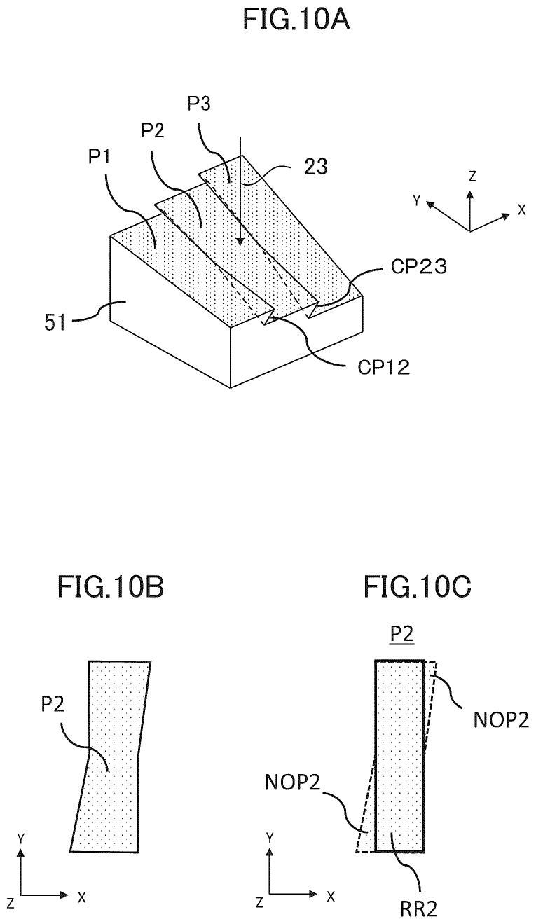

The slice mirror 51 that is an optical element according to the fifth embodiment will be described. FIG. 10A is a schematic perspective view illustrating an appearance of the slice mirror 51. For convenience of illustration, the slice mirror 51 having three reflecting faces is illustrated, but the slice mirror 51 may have a greater number of reflecting faces.

In the slice mirror 51, a face P1, a face P2, and a face P3 are arranged at positions irradiated with the incident light 23 incident through the incidence slit 24 (FIG. 1). The face P1 and the face P2 are connected by a connection face CP12, and the face P2 and the face P3 are connected by a connection face CP23. In the following description, a portion including the connection face CP12 and protruding in the X-minus direction and a portion including the connection face CP23 and protruding in the X-minus direction may be referred to as eaves portions.

Similarly to the first embodiment, each of the face P1, the face P2, and the face P3 includes a reflecting region (optical region) that reflects the incident light 23 incident along the Z-minus direction, and a non-optical region that does not function as a reflecting region because it is not irradiated with the incident light 23.

FIG. 10B is a plan view of the face P2 viewed from the direction (Z direction) of the incident light. As illustrated, the face P2 has a hexagonal shape. FIG. 10C illustrates a plan view of the face P2 in which the region RR2 functioning as a reflecting face is distinguished from the region NOP2 (non-optical region) that is shaded by the eaves portion and is not irradiated with the incident light 23. It can be seen that, while the region RR2 functioning as a reflecting face is rectangular, the width in the lateral direction (X direction) of each of the regions NOP2 (non-optical regions) arranged at two places changes along the longitudinal direction (Y direction) of the face P2. In FIGS. 10B and 10C, the face P2 is exemplified, but the face P1 and the face P3 are similarly formed.

In the present embodiment, similarly to the first and second embodiments, the region RR having a high surface shape accuracy is set as a reflecting face (optical face) and the region NOP having a low surface shape accuracy is set as a non-optical region. Therefore, the plane spectroscopic device 21 including the slice mirror 51 can exhibit high spectroscopic accuracy.

In addition, similarly to the first embodiment and second embodiment, the slice mirror 51 according to the present embodiment has an advantage in that the reflecting region is maintained with high shape accuracy even when the temperature changes, and the change in optical characteristics is small. The plane spectroscopic device 21 including the slice mirror 51, which changes the optical path of reflected light little even when cooled, can achieve high spectroscopic accuracy.

### Modification

Note that the present disclosure is not limited to the embodiments described above, and many modifications can be made within the technical spirit of the present disclosure. For example, all or some of the different embodiments and examples described above may be combined for implementation.

For example, the curved surface shape described in the third embodiment may be used for the reflecting face of the slice mirror of the fourth or fifth embodiment.

In the example described with reference to FIG. 11, the substrate SUB is covered with the metal film 7, and the reflective film (not illustrated) is further formed thereon, but the configuration and the manufacturing method are not limited to this example as long as the region RR included in each face P has high shape accuracy and a reflection function. For example, the region RR may be formed by mirror-finishing the substrate SUB itself without providing the metal film 7 or the reflective film. Alternatively, the reflective film may be directly formed on the substrate SUB, or the region RR may be formed by mirror-finishing the metal film 7 formed on the substrate SUB without providing the reflective film.

The present embodiments can be suitably implemented in an optical system used in a temperature environment lower than normal temperature (e.g., 293° C.), not limited to an optical system that cools an optical element using a cooling device.

According to the present disclosure, it is possible to provide an optical system in which a reflecting face has high shape accuracy and a change in optical characteristics is small even when the temperature changes.

Furthermore, the contents of disclosure in the present specification include not only contents described in the present specification but also all of the items which are understandable from the present specification and the drawings accompanying the present specification. Moreover, the contents of disclosure in the present specification include a complementary set of concepts described in the present specification. Thus, if, in the present specification, there is a description indicating that, for example, “A is B”, even when a description indicating that “A is not B” is omitted, the present specification can be said to disclose a description indicating that “A is not B”. This is because, in a case where there is a description indicating that “A is B”, taking into consideration a case where “A is not B” is a premise.

### OTHER EMBODIMENTS

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-111255, filed Jul. 10, 2024, and Japanese Patent Application No. 2024-111256, filed Jul. 10, 2024, which are hereby incorporated by reference herein in their entirety.

What is claimed is:

1. An optical element comprising:
a first face having a first reflecting region where a part of a light flux incident from a predetermined direction is reflected in a first direction, and a first non-optical region where the light flux is not incident;
a second face having a second reflecting region where another part of the light flux incident from the predetermined direction is reflected in a second direction different from the first direction; and
a third face connecting the first non-optical region and the second reflecting region,
wherein the first non-optical region and the third face form an acute angle outside the optical element, and
the second reflecting region and the third face form an acute angle inside the optical element.

2. The optical element according to claim 1, wherein
a normal line passing through a center of gravity of the first reflecting region with respect to the first face is not parallel to a normal line passing through a center of gravity of the second reflecting region with respect to the second face.

3. The optical element according to claim 1, wherein
a width in a lateral direction of the first non-optical region changes along a longitudinal direction of the first reflecting region.

4. The optical element according to claim 1, wherein
each of the first reflecting region and the second reflecting region has a flat surface or a concave surface.

5. The optical element according to claim 1, wherein
each of the first reflecting region and the second reflecting region is rectangular, trapezoidal, or hexagonal.

6. The optical element according to claim 1, wherein
any one of a metal film, a reflective film, and a mirror-finished substrate is disposed on at least the first reflecting region of the first face and at least the second reflecting region of the second face.

7. An optical device comprising:
the optical element according to claim 1; and
a cooling device configured to cool the optical element.

8. An optical device comprising:
the optical element according to claim 1;
a flat mirror array configured to reflect a plurality of split light fluxes reflected by the optical element; and
a curved mirror array configured to reflect images reflected by the flat mirror array toward an emission slit.

9. An optical device comprising:
the optical element according to claim 1;
a pupil mirror configured to one-dimensionally arrange a plurality of split light fluxes reflected by the optical element; and
a slit mirror configured to emit images arranged by the pupil mirror in a slit shape toward a spectroscope.

10. An optical system that splits an incident light flux, the optical system comprising:
a slice mirror including a first face having a first reflecting region where a part of the light flux is reflected in a first direction, a second face having a second reflecting region where another part of the light flux is reflected in a second direction different from the first direction, and a third face connecting the first face and the second face,
wherein in the slice mirror,
a region closer to the second face than the first reflecting region in the first face is hidden by a shadow of a portion defined by the second face and the third face, and is not irradiated with a light flux incident from a predetermined direction, and
the first reflecting region and the second reflecting region are arranged to be irradiated with the light flux incident from the predetermined direction.

11. The optical system according to claim 10, wherein
in a case where the region not irradiated with the light flux incident from the predetermined direction on the first face of the slice mirror is defined as a first non-optical region,
the first non-optical region and the third face form an acute angle outside the slice mirror, and
the second reflecting region and the third face form an acute angle inside the slice mirror.

12. The optical system according to claim 10, wherein
a normal line passing through a center of gravity of the first reflecting region with respect to the first face is not parallel to a normal line passing through a center of gravity of the second reflecting region with respect to the second face.

13. The optical system according to claim 10, wherein
in a case where the region not irradiated with the light flux incident from the predetermined direction on the first face of the slice mirror is defined as a first non-optical region,
a width in a lateral direction of the first non-optical region changes along a longitudinal direction of the first reflecting region.

14. The optical system according to claim 10, wherein
each of the first reflecting region and the second reflecting region has a flat surface or a concave surface.

15. The optical system according to claim 10, wherein
each of the first reflecting region and the second reflecting region is rectangular, trapezoidal, or hexagonal.

16. The optical system according to claim 10, wherein
any one of a metal film, a reflective film, and a mirror-finished substrate is disposed on at least the first reflecting region of the first face and at least the second reflecting region of the second face.

17. An optical device comprising:
the optical system according to claim 10; and
a cooling device configured to cool the slice mirror.

18. An optical device comprising:
the optical system according to claim 10;
a flat mirror array configured to reflect a plurality of split light fluxes reflected by the slice mirror; and
a curved mirror array configured to reflect the light fluxes reflected by the flat mirror array toward an emission slit.

19. An optical device comprising:
the optical system according to claim 10;
a pupil mirror configured to one-dimensionally arrange a plurality of divided light fluxes reflected by the slice mirror; and
a slit mirror configured to emit the light fluxes arranged by the pupil mirror in a slit shape toward a spectroscope.

20. An optical device comprising:
the optical system according to claim 10; and
a light receiving sensor configured to receive a plurality of split light fluxes reflected by the slice mirror.
